(19) United States
(12) Patent Application Publication
(10) Pub. No.: US 2014/0033045 A1
(43) Pub. Date: Jan. 30, 2014

(54) GESTURES COUPLED WITH VOICE AS INPUT METHOD

(71) Applicant: Sudhir Kshirsagar, Palo Alto, CA (US)

(72) Inventor: Sudhir Kshirsagar, Palo Alto, CA (US)

(73) Assignee: Global Quality Corp., Convington, KY (US)

(21) Appl. No.: 13/949,223

(22) Filed: Jul. 23, 2013

Related U.S. Application Data
(60) Provisional application No. 61/674,860, filed on Jul. 24, 2012.

(51) Int. Cl. G06F 3/16

(52) U.S. Cl. CPC G06F 3/167
USPC 715/728

(57) ABSTRACT

A user interface is provided for one or more users to interact with a computer using gestures coupled with voice to navigate a network that is displayed on the computer screen by the computer application software. The combination of a gesture with a voice command is used improve the reliability of the interpretation of the intent of the user. In addition, the active user who is allowed to control the software is identified through the combined input and the movements of other users are discarded.

### BACKGROUND

Displays of large networks are commonly accomplished through the use of wall size displays or through the use projection units capable of projecting a large image. Efficient interaction of multiple users with such large displays of networks is not feasible through the use of a computer mouse or a computer mouse like device where only a single user is able to control the interaction with the computer. Handing-off a mouse to another user in a group of users is not a convenient method for transferring software application control in a collaborative environment.

Network representations of information are commonly used in a large number of disciplines, and some examples include computer networks, water distribution networks, road networks and social networks. For example, in a computer network representation, a node represents a computer or a router and link represents the cable or the channel connecting two computers. A user may select a node in the network to get more information about that computer or select a link to examine the amount of traffic or flow in that link. The size of the networks that are displayed has grown substantially. For example, a 50,000 node network with 50,000 links is not uncommon for representing the drinking water distribution network of a city with one million people. Larger displays including projected images from projection devices are commonly used to handle the display of such networks. The existing methods of user interaction are not suitable for navigating such large displays from a distance in a collaborative setting where multiple users may be present.

### BRIEF SUMMARY OF THE INVENTION

The invention allows one or more users to interact with a computer using gestures coupled with voice to navigate a network that is displayed on the computer screen by the computer application software.

### BRIEF DESCRIPTION OF THE DRAWINGS

FIG. 1. Shows prior art

FIG. 2. Illustrates information flow in the invention

FIG. 3. Presents an embodiment of a combined gesture-based and voice-based user interaction system

### DETAILED DESCRIPTION AND BEST MODE OF IMPLEMENTATION

The invention provides an improved system and method for carrying out common network navigation tasks such as selecting a node or a link to get more information about those objects, zooming into a particular area of a network, and panning to a different part of a network. The invention is not limited to just these tasks but can be used to efficiently perform a variety of additional network management and exploration tasks.

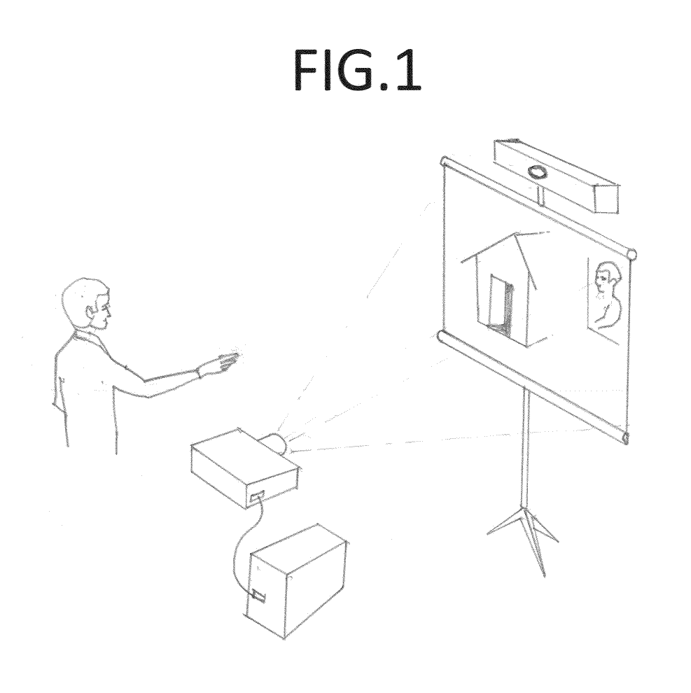

FIG. 1—(prior art) shows an embodiment of a gesture recognition and visual feedback system where a user may operate a software application through gestures. An image capturing device mounted near the computer display captures the user's movements in a continuous video stream that is transferred to the computer for extracting meaningful gestures. A visual feedback may be displayed on the screen to assist the user in operating and controlling a device.

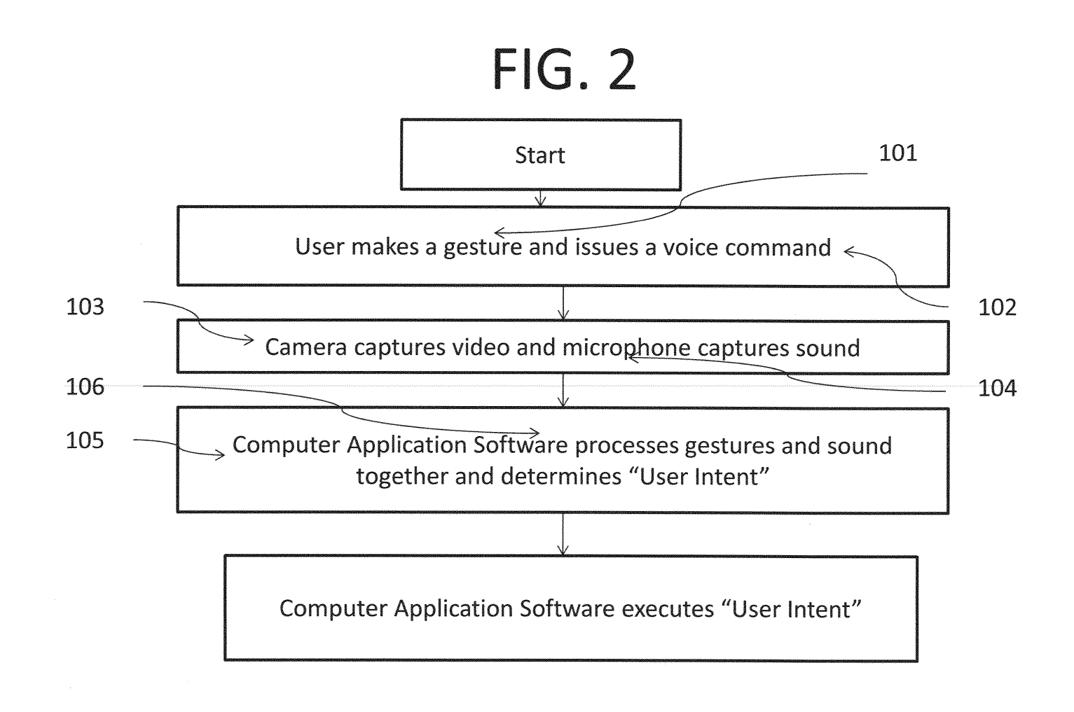

Unlike the prior art gesture-based systems, the invention combines both gestures and voice commands to improve the reliability of the interpretation of the user intent. FIG. 2 illustrates the information flow in the invention. User gesture 101 and the User voice command 102 are captured by the camera 103 and voice capture 104 units which may be a single device or multiple devices. The device processes the information and transfers the information to the computer 105. The computer application software 106 processes that information further to determine which specific action is being requested by the user. The requested action is then executed to revise the display and provide the new information to the user. The active user who is allowed to control the software application is also identified through the combined input and the motion captured from the other users is discarded.

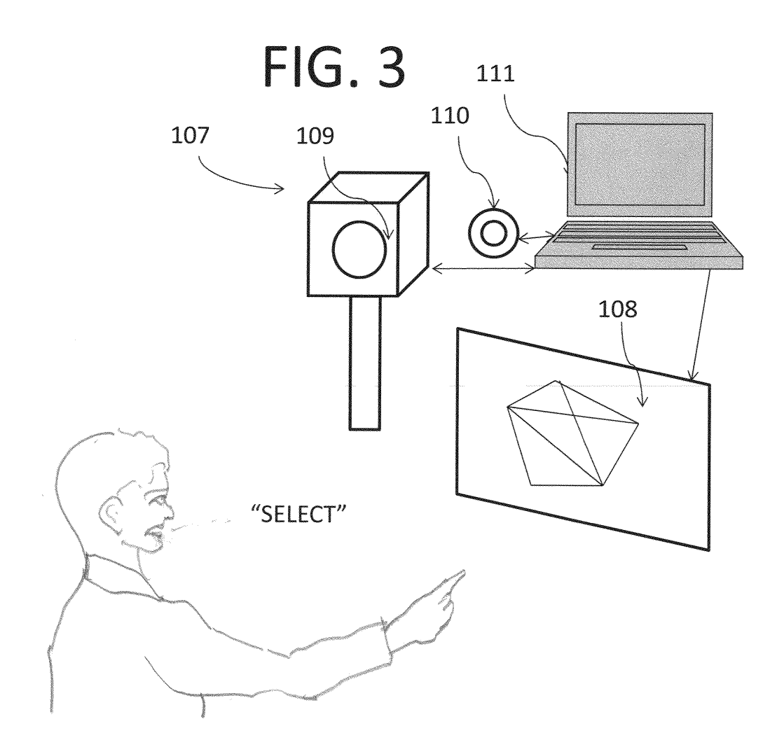

FIG. 3 depicts an embodiment of the combined gesture and voice based user interaction system 107 that can be used to navigate the display of a large network 108. A user may interact with display created by a computer by selecting a node or a link through a gesture and issuing a voice command “SELECT.” The user can zoom into a portion of a network by performing another gesture and issuing the voice command “ZOOM.” The user can pan the network by performing a different gesture and issuing the voice command “PAN.” The invention is not limited to the use of specific gestures or specific words for the voice commands. The invention is also not limited to the navigation of two dimensional network representations. Three dimensional network representations can be effectively navigated as well through the use of additional gestures and voice commands.

Alternative embodiments may consist of computer displays that capable of projecting stereoscopic 3D images. The computer may not be a physical computer connected to the display, and the display may be controlled through a cloud computing environment.

### REFERENCES

### Incorporated Herein by Reference

U.S. Pat. No. 6,160,899 A “Method of application menu selection and activation using image cognition”, Dec-2000

US 2009/0077504 A1 “Processing of Gesture-Based User Interactions”, Mar-2009

US 2011/0107216 A1 “Gesture-based User Interface”, May-2011

US 2012/0110516 A1 “Position Aware Gestures with Visual Feedback as Input Method”, May-2012

I claim:

1. A method and system of navigating a network display comprising: a) user gestures and voice command as user input, b) selecting node(s) and link(s) based on the user input, c) zooming in the network based on the user input, d) panning the network based on user input, and d) performing additional network navigation related tasks based on the user input.
